(19) United States
(12) Patent Application Publication
(10) Pub. No.: US 2003/0221356 A1
(43) Pub. Date: Dec. 4, 2003

(54) Locking tweezers for securing beads or weights used in tying fishing flies

(76) Inventor: Thomas Trozera, Del Mar, CA (US)

Correspondence Address: MICHAEL E. KLICPERA, PO BOX 573, LA JOLLA, CA, 92038-0573, US

(21) Appl. No.: 10/156,395

(22) Filed: May 28, 2002

(51) Int. Cl. A01K 1/00

(52) U.S. Cl. 43/4

(57) ABSTRACT

Bead or weight holding tweezers which are engageable with beads and beads or weights and is formed from either metallic or polymeric material and includes a pair of substantially parallel legs that extend from a proximal joint end. Each end of the legs of the bead or weight tweezers is formed with an inwardly directed concave member which has a friction bearing surface that will fixedly engage to a bead or weight. Furthermore, the tweezers are fitted with a locking slide that when moved in the distal direction, flexes said legs together and holds the bead or fishing weight between said concave portions. Thereby facilitating the ability to successfully slide the bead or weight onto a desired position on the hook.

### FIELD OF THE INVENTION

The present invention pertains generally to bead or weight holding tools. More particularly, the present invention pertains to a specifically configured pair of tweezers that function to effectively assist one in threading and holding a fishing bead or weight or other similar items, to thread over a hook, fishing line or other accessory.

### BACKGROUND OF THE INVENTION

The use of fishermans' pliers, tweezers or fishing tools for the purposes of holding, tying, and retaining one member (e.g. bead or small weight) relative to another body (e.g. a fishing hook) has been widely practiced for some time. Exemplary of early devices which were designed and intended for use as fishing tools is U.S. Pat. No. 5,568,698 which was issued to Harding on Oct. 29, 1996, for an invention entitled “Multipurpose Fishing Tool”. Another example of fishing pliers is provided by U.S. Pat. No. 5,207,012 which issued to Lael on May 4, 1993 for an invention entitled “Fisherman's Pliers”. Still another example of a fishing pliers is provided by U.S. Pat. No. 4,796,318 which issued to Bigej on Jan. 10, 1989 for an invention entitled “Fisherman's Pliers”. Lastly, another example of a fishing pliers is provided by U.S. Pat. No. 5,889,954 which issued to Trozera on Mar. 23, 1999 for an invention entitled “Locking Tweezers for Tying Fly-Fishing Hooks”. Each of these examples are typical of the types of fishing tools or pliers which rely on an inherent ability of the tools or pliers to reconfigure itself for complete engagement of the distal tip with a particular item.

In many applications it is desirable that fishermens' pliers or tweezers provide a stable fastening means against which a structure, such as a bead head or fishing weight, that can be positioned and held stationary. To accomplish this, however, it is necessary for the operator of the fishing tool to maintain hand or finger pressure on the handle end of the pliers or tweezers to maintain engagement of the distal gripping means with the bead head or small weight. While the pliers or tweezers are engaged with the bead head, the tweezers, in the present invention, are used to facilitate threading the bead head over the fishing hook shaft and position it in a predetermined location for tying.

In addition to the functional considerations mentioned above, it is also of practical importance that the tweezers be easily engaged with and disengaged from the particular bead head or weight with which it cooperates. The preferred method for maintaining engagement, of course, would, be a one-step locking operation wherein the legs of the tweezers are flexed towards each other, forcing the distal holding means to engage a bead head or weight.

Likewise, the preferred method for disengagement would be effectively another one-step operation. The present invention incorporates a sliding locking mechanism which flexes the legs towards each other when moved to its distal direction and unflexes the legs when the moved to its proximal position.

In light of the above, it is an object of the present invention to provide lockable tweezers for holding a bead head or other weight means to facilitate the threading, holding and securing of the bead head or small weight over a fishing hook or fishing line.

It is another object of the present invention to provide a locking mechanism which can be slid distally or proximately along the pair of legs in a one-step operation.

Still another object of the present invention is to provide a lockable tweezers for holding and securing fishing beads or weights that is relatively easy to manufacture, simple to operation and comparatively cost effective.

### SUMMARY OF THE PREFERRED EMBODIMENTS

A lockable tweezer for holding fishing beads or weights comprising a pair of flexible legs which extend generally parallel to each other that are joined at their proximal (upper) ends. Each leg has an inwardly directed receiving member formed at the distal ends opposite the proximal (upper) end. Further, the legs are flexed such that the holding members are do not engage each other, forming a gap between, in its open, relaxed state. As intended for the present invention, in order to engage the holding members with the fishing bead or weight, the object is positioned within the gap and between the holding members of the tweezers. A locking slide is moved from its proximal position to its distal position, causing the legs of the tweezers to flex and move towards each other, closing the gap. As a result of moving the slide to its distal locking position, the holding members encase a portion and become firmly engaged with the bead head or weight. As intended for the present invention, the engagement of the tweezers with the bead head or weight is accomplished in a lockable, one-step, operation. The particular structure of the tweezers makes this possible.

At their respective ends, opposite the proximal ends, each leg of the tweezers is formed with an inwardly directed holding member. Specifically, each holding member is formed by a concave depression that is generally designed to match the spherical dimensions of the bead head or weight.

In the operation of the bead or weight holding tweezers of the present invention, the bead head or weight is located and positioned with a gap between the holding members with the hole or gap of the weight positioned to receive the shaft of the fishing line not obscured by the tweezers legs. While holding the bead head or weight between the holding members, the locking member is moved from its proximal position to its distal position, causing the flexible legs to move towards each self and close the gap. At this locked position, the bead head or small weight is engaged with the receiving members.

Once the bead head or small weight is firmly engaged, the hook receiving hold is aligned with the shaft of the hook and, using the tweezers, slid up the shaft and around the hooks bend to a final predetermined position.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the bead or weight holding tweezers of the present invention engaging a bead or weight with the locking slide in the distal position.

FIG. 2 is a side view of the present invention as seen in FIG. 1 with the locking slide in the proximal position.

FIG. 3 is a side view of the present invention as seen in FIG. 1 with the locking slide in the distal position.

FIG. 4 is a side view taken at 90 degrees rotation from FIGS. 2 and 3 of the bead or weight holding tweezers demonstrating the gap and relaxed configuration of the tweezers.

FIG. 5 is a partial view of distal end of the bead or weight holding tweezers' legs demonstrating one configuration of the holding and securing means in the located in the distal sections of the parallel legs.

FIG. 6 is a partial view of the distal end of another embodiment of the weight holding tweezers demonstrating one configuration of the holding and securing means located in the distal sections of the parallel legs.

FIG. 7 is a partial view of the distal end of the weight holding tweezers showing the bead or weight engaged and secured by the holding means on the legs.

### DESCRIPTION OF THE PREFERRED EMBODIMENTS

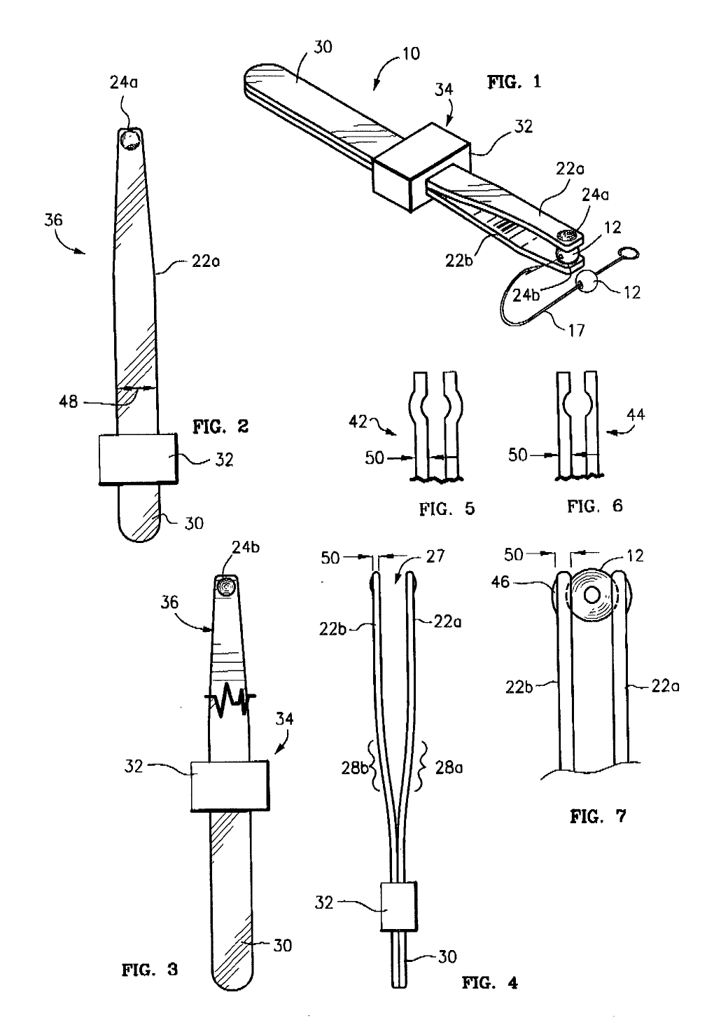

Referring initially to FIG. 1, the bead or weight holding tweezers of the present invention are shown and designated 10. Specifically, as seen in FIG. 1, the bead or weight holding tweezers 10 have been engaged with bead or weight 12 by holding members 24a and 24b. Locking member 32 is in its distal position 34 and is forcing the legs of the tweezers towards each other. The tweezers will facilitate threading beads or weights over a typical fishing hook 17.

The purpose for engaging the bead or weight holding tweezers 10 with the fishing item, as illustrated in FIG. 1, is to facilitated holding and maintaining the bead or weight 12 in a desired position relative to the fishing hook or fishing line.

The specific details of the bead or weight holding tweezers 10 will be further appreciated by reference to FIGS. 1 and 2. There it will be seen that the legs 22a and 22b of the bead or weight holding tweezers 10 are formed from a metallic material when intended for substantial long-term use or of a polymeric material when they are to be discarded after minimal use. For purposes of the present invention, the metallic material that is to be used for the legs 22a and 22b can be made of any material which has sufficient strength and flexibility to perform the functions required for operation of the bead or weight holding tweezers 10. Preferably the legs are comprised of a spring steel or similar polymer, enabling then to be flexed together to the position shown in FIGS. 1 and 7, and then released to spread apart and form a gap 27 as shown in FIG. 4. The resistance to flexing is of course determined not only by the gauge and physical characteristics of the material used, but also by the width of each leg 31. When a polymeric material is employed for the legs, again, any polymeric material that has sufficient strength and flexibility to perform the functions required for operation of the bead or weight holding tweezers 10.

Legs 22a and 22b are joined together at their upper proximal end 30, as by forming them integrally from a single piece of metal. Either formed as an integral portion or as individual structures, a pair of holding members 24a and 24b are positioned on the inner surface of each leg 22a and 22b near the distal end.

FIG. 3 is another side view of the bead weight holding tweezers 10. Shown in this view is a side view of one leg 22a or 22b with tapered sides 36a and 36b. The locking slide 32 is shown in its distal position 34 that forces the legs to move towards each other, reducing the gap to engage the bead or weight.

FIG. 4 is 90 degree rotated side view of the bead or weight holding tweezers 10. Shown in this view is a side view of one leg 22a or 22b with joined proximal section 30. The locking slide 32 is shown in its proximal position that allows the legs to relax and form gap 27.

Shown, perhaps, best in FIG. 4, Legs 22a and 22b are also configured to include arcuate camming portions 28a and 28b. Engaged over the legs and arcuate camming portions is a locking slide 32 with a rectangular opening designed to receive legs 22a and 22b. Locking slide 32 can be fabricated from either a preferred polymeric or an alternate metallic material. The polymeric or metallic material that is to be used for locking slide 32 can be made of any material that has sufficient strength and a low coefficient of friction to perform the functions required for operation of the bead or weight holding tweezers 10. For purposes of disclosure here, upper end 30 will sometimes be referred to as being at the proximal end and the separated ends near holding members 24a and 24b referred to as being at the distal end of the weight holding tweezers 10. Closure and locking of the gap between the legs is facilitated by moving slide 32 from its unbiased proximal position to its distal locking position 34. It is equally important, however, that the legs 22a and 22b be able to return to the relaxed, unstressed configuration shown in FIG. 4. This ability to return to the unstressed relaxed configuration is facilitated by the resilience of the legs 22a and 22b. Therefore, moving the locking slide 32 to its proximal position allows the legs to spread apart and assume their normal, open position as shown in FIG. 2.

FIG. 5 demonstrates a first embodiment of the present invention whereby the distal holding member 42 is formed by physically dislodging a portion of the distal end of each leg (22a, 22b) in a specific configuration that results in a general concave dimple on each inwardly facing surface. In this embodiment, the thickness 50 of the legs is generally constant from the tip of the leg, through the deflected area, and just proximal to the deflected area. When using some specific metallic elements to fabricate the legs, the dislodging process will result in some work hardening of the disloged area. The manufacturing techniques for dislodging the distal end of the leg that results in the concave configuration is art already known.

FIG. 6 demonstrates another embodiment of the present invention whereby the distal holding members 44 are fabricated by removing a portion of the distal end of the pair of legs (22a, 22b) that results in a concave dimple on each inwardly facing surface. In this embodiment, the thickness 50 of the legs is not constant from the tip of the leg, through the concave deflected area, and just proximal to the deflected area. Rather, the thickness 50 of the legs is substantial enough to allow the removal of material without sacrificing overall strength. Material is removed from the distal end of the leg to form a concave shape on each of the inwardly facing surfaced of the legs. The manufacturing techniques for removing material from the distal end of the leg that results in the concave configuration is art already known.

FIG. 7 demonstrates the present invention with the distal holding means 24 securing a typical fishing bead or weight. These beads or weights are generally composed of brass, tungsten, stainless steel, copper, or other suitable metallic or polymeric materials. The beads or weights are generally spherical with nominal diameter. As shown, the concave shape of the tweezer's distal leg is designed to generally engage the outside surface of the spherical bead or fishing weight.

Exact values for the dimensions for the many of structures described in this specification are unimportant. What matters for some are their relative values. The relative dimension between the gap 27 of the weight holding tweezers 10 and the diameter of the bead or fishing weight 12 are important in that the gap 27 should be larger enough to easily receive the bead or fishing weight 12 but not be so wide as to make it difficult to maintain the position of the bead or weight within the gap when the legs are flexed towards each other. In addition, the length of rectangular opening of lockable slide 32 must be dimensioned to closely fit the width 48 of the tweezers 10. Furthermore, the width of rectangular opening of lockable slide 32 must be dimensioned to closely ride over arcuate camming surface 28a and 28b to force the legs 22a and 22b towards each other resulting in a final configuration were the holding members 24a and 24b are firmly engaged.

### Operation

In the operation of the bead or weight holding tweezers 10 of the present invention, the bead or fishing weight 12 is first positioned within the aperture or gap 27 between holding means 24a and 24b as shown in FIGS. 1 and 7. The locking slide 32 is then advanced towards the distal position 34 forcing the legs 22a and 22b towards each other and firmly engaging bead or fishing weight 12 between the holding means.

The tweezers now can be guided such that the bead or weight can be threaded over a particular fishing hook or piece of fishing line. Once bead or fishing weight 12 is positioned, the locking slide 32 is retracted towards it proximal stopped position, allowing the legs 22a and 22b to relax and release engagement with the bead or fishing weight 12.

While the particular bead or weight holding tweezers as herein shown and disclosed in detail are fully capable of obtaining the objects and providing the advantages herein before stated, it is to be understood that it is merely illustrative of the presently preferred embodiments of the invention and that no limitations are intended to the details of construction or design herein shown other than as described in the appended claims.

I claim:

1. Tweezers for holding beads and fishing weights comprising:
a pair of flexible legs fixedly joined at their proximal ends, each said leg having an end opposite said proximal joint;
inwardly facing concave holding means position on said opposite ends of said legs; and
arcuate camming surfaces on the outside of said legs intermediate the ends thereof;
a locking slide embracing said legs to slidable engage over said arcuate camming surfaces so that when moved from a proximal position to a distal position, said lock slide flexes said legs together and forces said gripping portions together;

2. Tweezers for holding and attaching beads or weights as recited in claim 1 wherein said legs are made of a metallic material.

3. Tweezers for holding and attaching beads or weights as recited in claim 1 wherein said legs are made of a polymeric material.

4. Tweezers for holding and attaching beads or weights recited in claim 1 wherein said lock slide is made of a metallic material.

5. Tweezers for holding and attaching beads or weights as recited in claim 1 wherein said lock slide is made of a polymeric material.
